(19) United States
(12) Patent Application Publication
(10) Pub. No.: US 2019/0239685 A1
(43) Pub. Date: Aug. 8, 2019

(54) INTERCHANGABLE FOOD COOKING SYSTEM

(71) Applicant: Gokulakrishnan Sankar, Arlington, TX (US)

(72) Inventor: Gokulakrishnan Sankar, Arlington, TX (US)

(21) Appl. No.: 16/266,031

(22) Filed: Feb. 2, 2019

Related U.S. Application Data
(60) Provisional application No. 62/625,513, filed on Feb. 2, 2018.

(51) Int. Cl. A47J 37/06; A47J 37/08; A47J 27/00

(52) U.S. Cl. CPC A47J 37/0611; A47J 27/004; A47J 37/08

(57) ABSTRACT

An interchangeable food cooking system allow for various style cooking plates to be attached to a support to prepare food in corresponding ways. The cooking plates could be configured to cook waffles, toast bread, make pancakes, melt cheese, make sandwiches, grill vegetables or meat or fish or any other similar function.

### BACKGROUND

### 1. Field of the Invention

The present invention relates generally to food preparation systems, and more specifically, to systems for applying heat to alter the physical state of bread type doughs or foods to prepare them for consumption.

### 2. Description of Related Art

Food preparation systems are well known in the art and are effective means to cause physical or chemical changes to comestibles prior to presenting them for ingestion. For example, FIG. 1 depicts a conventional waffle iron apparatus 101 having an upper heating paddle 103 pivotally attached to a lower heating paddle 105. During use, batter is placed on the lower heating paddle 105 and the upper heating paddle 103 is brought down so that the paddles 103, 105 transfer heat to the batter until it is cooked.

One of the problems commonly associated with apparatus 101 is its limit use. For example, the waffle iron 101 is able to prepare waffles (cooked batter), but its lack of heat control or shape of the heating paddles prevent it from toasting bread, making sandwiches and grilling food or other common food preparation tasks.

Additionally, each apparatuses must be stored when not in use often resulting in wasted space for long periods of time when not in use.

Accordingly, although great strides have been made in the area of waffle iron apparatuses, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a side view of a common waffle iron apparatus;

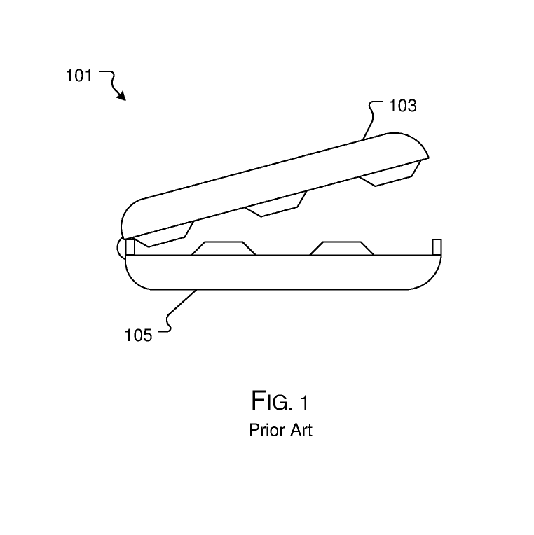

FIGS. 2A and 2B are side views of an interchange bread cooking system in accordance with a preferred embodiment of the present application; and

FIG. 3 is a top view of an alternative embodiment of the cooking plates of FIGS. 2A and 2B.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional waffle iron apparatuses. Specifically, the invention of the present application enables the alteration of the invention to suit the specific food preparation needs. The invention combines common elements of multiple cooking processes to limit the number of tools needed to perform multiple processes reducing wasted space while they are stored. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

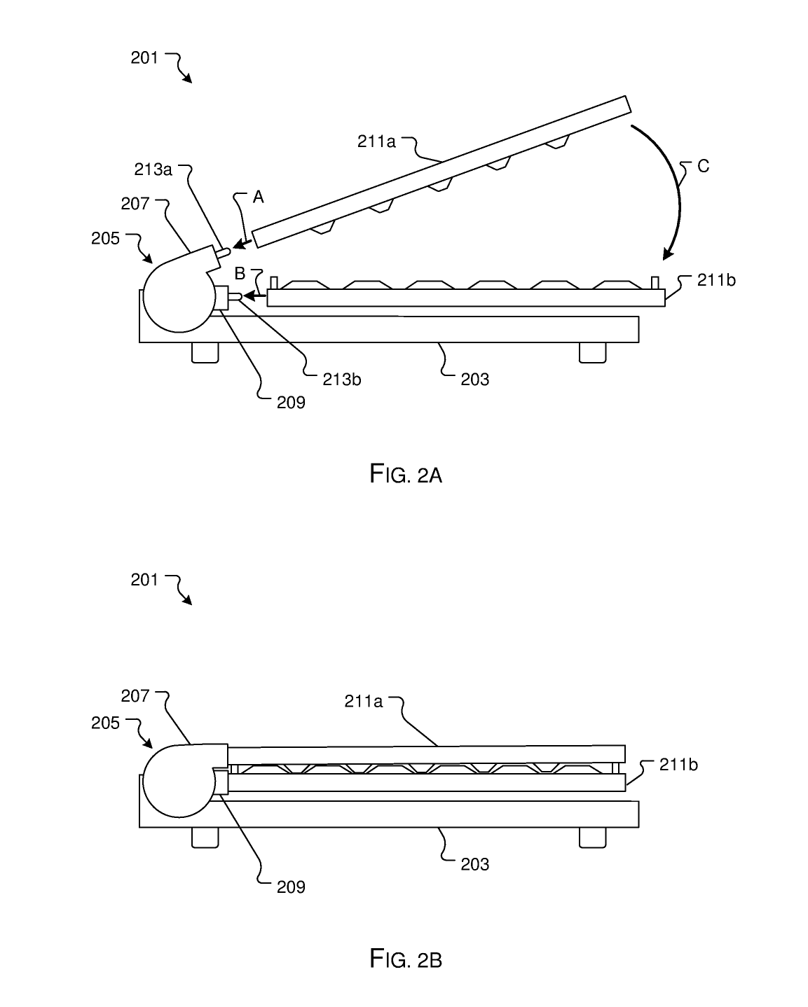

Referring now to the drawings wherein like reference characters identify corresponding or similar elements throughout the several views, FIGS. 2A and 2B depict side views of an interchangeable bread cooking system in accordance with a preferred embodiment of the present application. It will be appreciated that system 201 overcomes one or more of the above-listed problems commonly associated with conventional waffle iron apparatuses.

In the contemplated embodiment, system 201 includes a support 203 having a hinge 205. The hinge 205 having an upper joint 207 and a lower joint 209. The upper joint 207 and lower joint 209 being configured to accept and hold a cooking plate 211 as depicted by motions A and B. The plates 211 receive electricity from a prongs 213 to heat the plates 211 and cook the food stuffs placed between them when closed via hing 205 as shown by motion C.

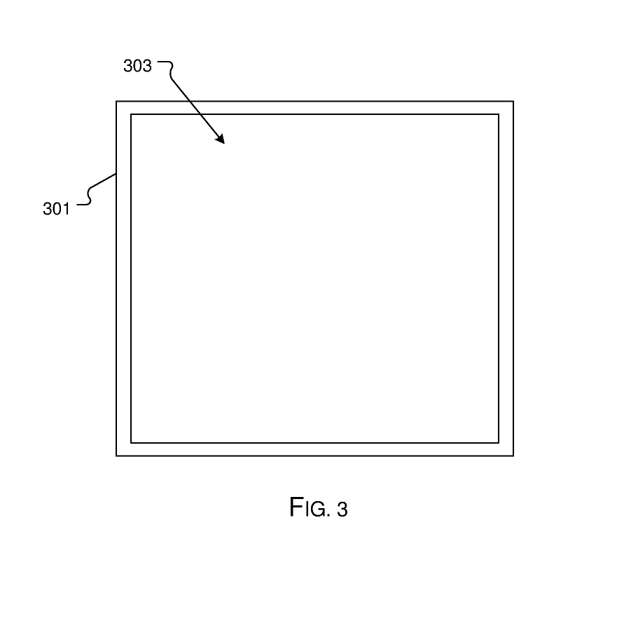

It should be appreciated that one of the unique features believed characteristic of the present application is that cooking plates 211 are interchangeable, allowing for switching the plates to accommodate different cooking types. While the cooking plates 211 depicted have indentions 215 to accommodate waffles, by referring to FIG. 3 cooking plates 301 that have an inner surface 303 that is flat to allow for toasting slices of bread or the like.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. An interchangeable food cooking system comprising:
a support having a hinge attached thereto; and
the hinge having an upper joint and lower joint pivotally attached via the hinge;
at least two cooking plates configured to attach to the upper joint and lower joint and receive electricity from a power source through the joints;
wherein the cooking plates heat food stuffs placed between them.

2. The cooking plates of claim 1 being configured to cook waffles.

3. The cooking plates of claim 1 being configured to toast bread, cook sandwiches or gill food.
